(19) United States
(12) Patent Application Publication
(10) Pub. No.: US 2026/0298294 A1
(43) Pub. Date: Oct. 1, 2026

(54) Torque-Limiting Coupling System for Use in Breakaway Mounting Systems for Roadway Signposts and Methods of Use

(71) Applicant: Loren Brian Nelson, Ralls, TX (US)

(72) Inventor: Loren Brian Nelson, Ralls, TX (US)

(21) Appl. No.: 19/635,770

(22) Filed: Mar. 31, 2026

Related U.S. Application Data
(60) Provisional application No. 63/780,664, filed on Mar. 31, 2025.

(51) Int. Cl. F16D 9/06; B25B 23/14; E01F 9/631

(52) U.S. Cl. CPC F16D 9/06; B25B 23/1415; E01F 9/631

(57) ABSTRACT

A torque-limiting coupling system for use in mounting systems, such as breakaway mounting systems for roadway signposts, is disclosed. The system includes a driven component having a first engagement feature, a driver component having a corresponding engagement feature, and a sacrificial torque-transfer element configured to be received within and engaged with the engagement features of both the driven component and the driver component. The sacrificial torque-transfer element transmits torque between the driver component and the driven component during installation and is configured to fail upon application of torque exceeding a predetermined threshold, thereby limiting further torque transmission. In this manner, the system provides controlled and repeatable torque application, preventing over-tightening and/or under-tightening of fasteners and promoting consistent performance of the mounting system.

### CROSS-REFERENCE TO RELATED APPLICATIONS

This application claims the benefit of U.S. Provisional Application No. 63/780,664, filed Mar. 31, 2025, the entirety of which is hereby incorporated by reference herein.

### BACKGROUND OF THE INVENTION

### 1. Field of the Invention

The present invention generally relates to mounting systems for breakaway roadway signposts, and more specifically relates to a torque-limiting coupling system used in connection with mounting systems for breakaway signposts.

### 2. Description of Related Art

Traffic signs communicate rules, warnings, guidance, and other highway agency information that drivers need to safely and efficiently navigate roads and streets. Such signs are typically supported by signposts or support structures positioned adjacent to roadways.

Due to their roadside placement, sign support posts can become a deadly hazard when struck by a vehicle. To mitigate this risk, the Federal Highway Administration (“FHWA”) and other transportation and roadway authorities require that roadside sign support posts be designed to be breakaway, yielding, or shielded by a barrier or crash cushion. Breakaway support posts are configured such that, upon vehicular impact, the sign support structure separates, bends, or otherwise yields in a controlled and predictable manner, thereby reducing damage to the vehicle and minimizing the risk of injury to occupants. This includes sign support posts that, when struck by a vehicle, separate from the base and are knocked ahead of, or up and over, the vehicle.

Conventional breakaway mounting systems commonly utilize slip-base configurations, such as assemblies including opposing plates secured together by fasteners (e.g., nuts and bolts). These systems are designed to provide sufficient structural stability under normal conditions, including wind loads and environmental forces, while permitting controlled separation when subjected to impact forces exceeding a predetermined threshold. It is critical that such mounting systems maintain proper alignment of the sign so that it faces approaching traffic and remains readable, while also preserving reliable breakaway performance. However, proper performance of these systems is highly dependent on the torque applied to the fasteners that secure the slip-base plates. If the fasteners are under-tightened, the sign assembly may shift, rotate, or become misaligned during normal operation. Conversely, if the fasteners are over-tightened, the breakaway function may be compromised. In particular, excessive torque can increase the force required for separation, thereby preventing low-energy breakaway and increasing the likelihood of significant vehicle damage and/or serious occupant injury upon impact.

In practice, over-torquing of slip-base fasteners is a common issue. Installers frequently use impact tools or apply manual torque without precise control, resulting in fasteners being tightened beyond recommended specifications. This variability in installation conditions leads to inconsistent and unreliable breakaway performance across installations, even when using otherwise compliant mounting systems.

Accordingly, there exists a need for improved systems and methods that provide controlled and repeatable torque application during installation of breakaway mounting systems. More specifically, there is a need for a torque-limiting coupling system that can be used in connection with existing or new mounting systems to prevent over-torquing of fasteners, ensure consistent breakaway performance, and improve overall safety and reliability of roadside sign support structures.

In view of the foregoing, the present disclosure provides a torque-limiting coupling system configured to control the amount of torque transmitted during installation of a mounting system, thereby addressing the deficiencies of existing systems and improving the safety and performance of breakaway roadway signpost assemblies. It is a purpose of this invention to fulfill this and other needs in the art which will become more apparent to the skilled artisan once given the following disclosure.

### OBJECTS AND SUMMARY OF THE INVENTION

It is an object of the present invention to overcome the above-described drawbacks associated with current mounting systems for breakaway signpost systems. To achieve these and other advantages, and in accordance with the purpose of the invention, as embodied and broadly described, the present disclosure describes a torque-limiting coupling system for use with mounting systems for breakaway roadway signposts.

In one or more embodiments, the disclosed torque-limiting coupling system includes a driven component having an engagement feature (e.g., a recess, slot, or keyway), a driver component having a corresponding engagement feature, and a sacrificial torque-transfer element configured to be received within the engagement features of both the driven component and driver component. In one exemplary embodiment, the driven component may include a generally round body having a female keyway formed therein, and the driver component may include a drive socket having a corresponding keyway. The sacrificial torque-transfer element is positioned such that it engages both keyways and transmits torque between the driver component and the driven component during installation.

Upon application of torque, the sacrificial torque-transfer element is configured to transmit rotational force up to a predetermined torque threshold. When the applied torque exceeds the predetermined threshold, the sacrificial element is configured to fail, such as by shearing, fracturing, or otherwise disengaging, thereby interrupting further torque transmission between the driver component and the driven component. In this manner, the torque-limiting coupling system provides a controlled and repeatable torque-limiting function.

When used in connection with slip-base mounting systems for breakaway roadway signposts (e.g., see prior art system shown in FIG. 17), the disclosed system prevents overtightening and/or under-tightening of fasteners (e.g., slip-base nuts and bolts), thereby preserving the intended breakaway characteristics of the mounting system. By optimizing the applied torque during installation, the system promotes consistent and predictable separation of the signpost from the mounting base under impact conditions. This controlled behavior reduces the likelihood of excessive structural resistance during impact and improves safety by facilitating low-energy breakaway of the sign support structure.

These, together with other objects of the invention, along with various features of novelty that characterize the invention, are pointed out with particularity in the claims annexed hereto and forming a part of this disclosure. For a better understanding of the invention, its operating advantages, and the specific objects attained by its uses, reference should be had to the accompanying drawings and descriptive matter in which there is described illustrative embodiments of the invention.

### BRIEF DESCRIPTION OF THE DRAWINGS

The accompanying drawings, which are incorporated in and form a part of the specification, illustrate embodiments of the present invention, and together with the description, serve to explain the principles of the invention. It is to be expressly understood that the drawings are for the purpose of illustration and description only and are not intended as a definition of the limits of the invention. In the drawings:

FIG. 1 is a perspective view of a torque-limiting driven component constructed in accordance with the teachings of the present disclosure.

FIG. 2 is a bottom view of a torque-limiting driven component constructed in accordance with the teachings of the present disclosure.

FIG. 3 is a side view of a torque-limiting driven component constructed in accordance with the teachings of the present disclosure.

FIG. 4 is a perspective view of a sacrificial torque-transfer element constructed in accordance with the teachings of the present disclosure.

FIG. 5 is a front view of a sacrificial torque-transfer element constructed in accordance with the teachings of the present disclosure.

FIG. 6 is a side view of a sacrificial torque-transfer element constructed in accordance with the teachings of the present disclosure.

FIG. 7 is a perspective view of a torque-limiting coupling system constructed in accordance with the teachings of the present disclosure.

FIG. 8 is a side view of a torque-limiting driver component constructed in accordance with the teachings of the present disclosure.

FIG. 9 is an exploded view of a torque-limiting driver component constructed in accordance with the teachings of the present disclosure.

FIG. 10 is a top view of a torque-limiting driver component constructed in accordance with the teachings of the present disclosure.

FIG. 11 is a perspective view of a base member of a torque-limiting driver component constructed in accordance with the teachings of the present disclosure.

FIG. 12 is a bottom view of a base member of a torque-limiting driver component constructed in accordance with the teachings of the present disclosure.

FIG. 13 is a perspective view of a center member of a torque-limiting driver component constructed in accordance with the teachings of the present disclosure.

FIG. 14 is a bottom view of a center member of a torque-limiting driver component constructed in accordance with the teachings of the present disclosure.

FIG. 15 is a perspective view of a top member of a torque-limiting driver component constructed in accordance with the teachings of the present disclosure.

FIG. 16 is a top view of a top member of a torque-limiting driver component constructed in accordance with the teachings of the present disclosure.

FIG. 17 is a perspective view of a prior art slip-base mounting system for breakaway roadway signposts.

### DETAILED DESCRIPTION OF ILLUSTRATIVE EMBODIMENTS

Exemplary embodiments of a torque-limiting coupling system of a mounting system for breakaway signposts in accordance with the present disclosure are discussed below. Many other uses of the present invention will become obvious to one skilled in the art upon acquiring a thorough understanding of the present invention. Once given the below disclosures, many other features, modifications and variations will become apparent to the skilled artisan in view of the teachings set forth herein. Such other features, modifications and variations are, therefore, considered to be a part of this invention.

The disclosed torque-limiting coupling system 20 includes a driven component 100 having a first engagement feature 102 (e.g., a recess, slot, or keyway), a driver component 300 having a corresponding engagement feature 304, and a sacrificial torque-transfer element 200 configured to be received within and engaged with the first engagement feature 102 of the driven component 100 and the corresponding engagement feature 304 of the driver component 300.

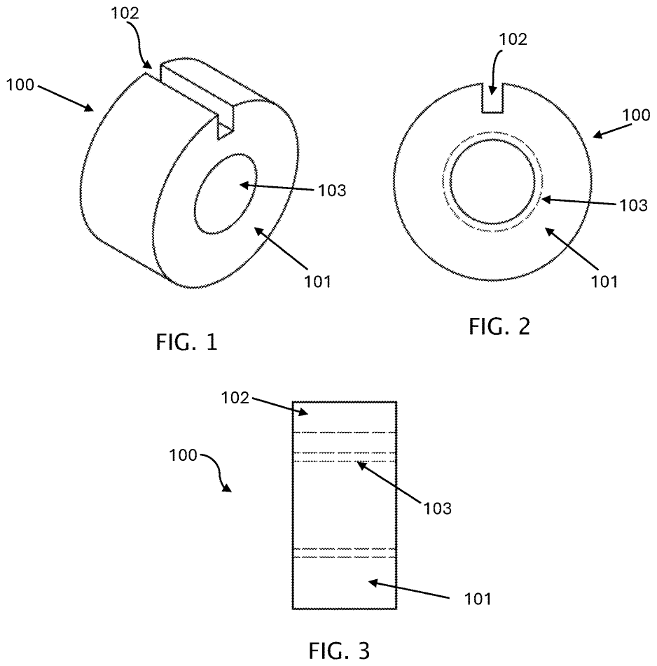

In one exemplary embodiment shown in FIGS. 1 and 2, the driven component 100 includes a body 101 having a generally round configuration, a threaded center 103 formed within the body 101 for receiving a threaded portion of a fastener (e.g., a bolt), and a first engagement feature 102 formed in the body 101. In this embodiment, the first engagement feature 102 may comprise a recess, slot, or keyway extending into the body 101. The first engagement feature 102 is arranged and configured to receive at least a portion of the sacrificial torque-transfer element 200, such that the sacrificial torque-transfer element 200 may engage the driven component 100 and facilitate torque transmission by transferring rotational force to the driven component 100, as described herein. The first engagement feature 102 may extend partially or fully through the body 101 and may have various configurations (e.g., a recess, slot, keyway, channel, or other configuration) selected to receive and engage the sacrificial torque-transfer element 200 (e.g., a shearable insert, pin, tab, or elongated member). In some embodiments, the sacrificial torque-transfer element 200 may include one or more elements.

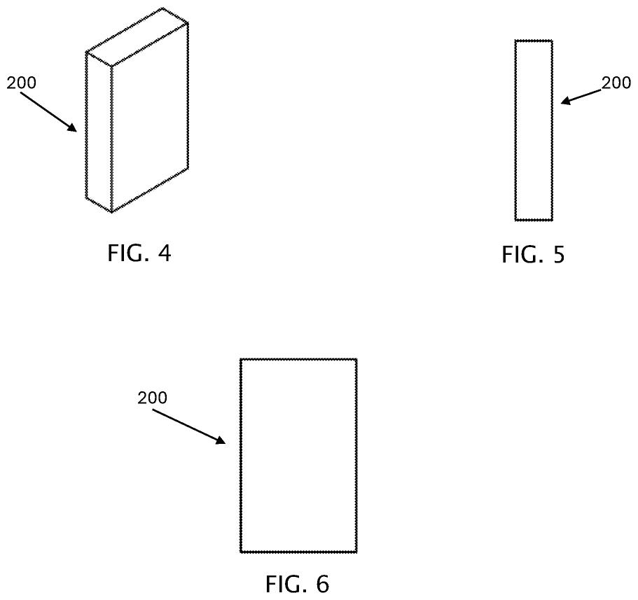

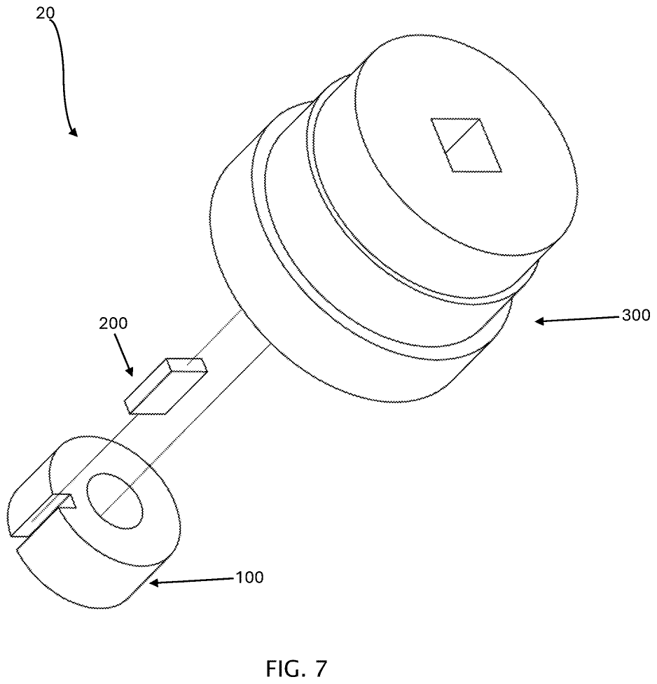

In the embodiments shown in FIGS. 4-6, the disclosed torque-limiting coupling system 20 includes a sacrificial torque-transfer element 200 configured to be received within the first engagement feature 102 of the driven component 100 and within the corresponding engagement feature 304 of the driver component 300. In one embodiment, the sacrificial torque-transfer element 200 may be inserted into the first engagement feature 102 prior to engagement with the driver component 300. The sacrificial torque-transfer element 200 may be formed from one or more materials, including metals, polymers, composites, or combinations thereof, as will be understood by those skilled in the art.

The sacrificial torque-transfer element 200 is arranged and configured to transmit torque between the driver component 300 and the driven component 100 during rotation of the driver component 300, such as when the driver component 300 is rotated by a driver tool. The sacrificial torque-transfer element 200 is further configured to fail when the applied torque reaches or exceeds a predetermined torque threshold. In various embodiments, the sacrificial torque-transfer element 200 may be configured to fail by shearing, fracturing, deforming, wearing, or otherwise disengaging, thereby interrupting further torque transmission between the driver component 300 and the driven component 100.

FIG. 7 illustrates an embodiment of the disclosed torque-limiting coupling system 20 comprising a driven component 100, a sacrificial torque-transfer element 200, and a driver component 300. As depicted, the sacrificial torque-transfer element 200 is received within the first engagement feature 102 of the driven component 100 and within the corresponding engagement feature 304 of the driver component 300 when the driver component 300 is positioned over the driven component 100. In this configuration, the sacrificial torque-transfer element 200 engages both the driven component 100 and the driver component 300, thereby establishing a torque-transmitting interface therebetween.

During operation, rotation of the driver component 300, such as by an installer using a driver tool, causes torque to be transmitted through the sacrificial torque-transfer element 200 to the driven component 100, thereby rotating the driven component 100. The driver component 300 may be configured for use with a variety of driver tools, including manual tools, powered tools, or impact tools. Torque is transmitted in this manner until the applied torque reaches or exceeds a predetermined threshold, at which point the sacrificial torque-transfer element 200 fails (e.g., by shearing), thereby interrupting further torque transmission. Following failure of the sacrificial torque-transfer element 200, continued rotation of the driver component 300 is decoupled from the driven component 100, such that additional rotation of the driver component 300 does not cause corresponding rotation of the driven component 100.

In one embodiment, the driver component 300 may be defined as a socket assembly that is configured to be rotated by an installer (e.g., using a common ratchet or an impact tool to rotate the socket assembly).

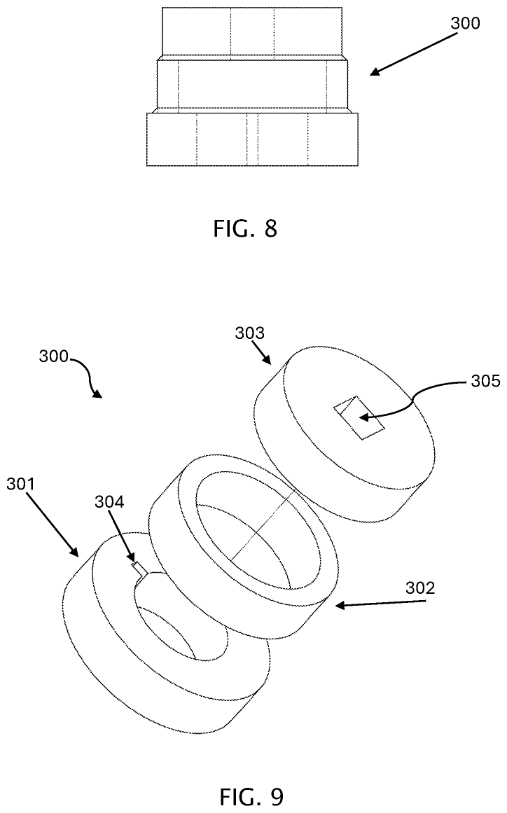

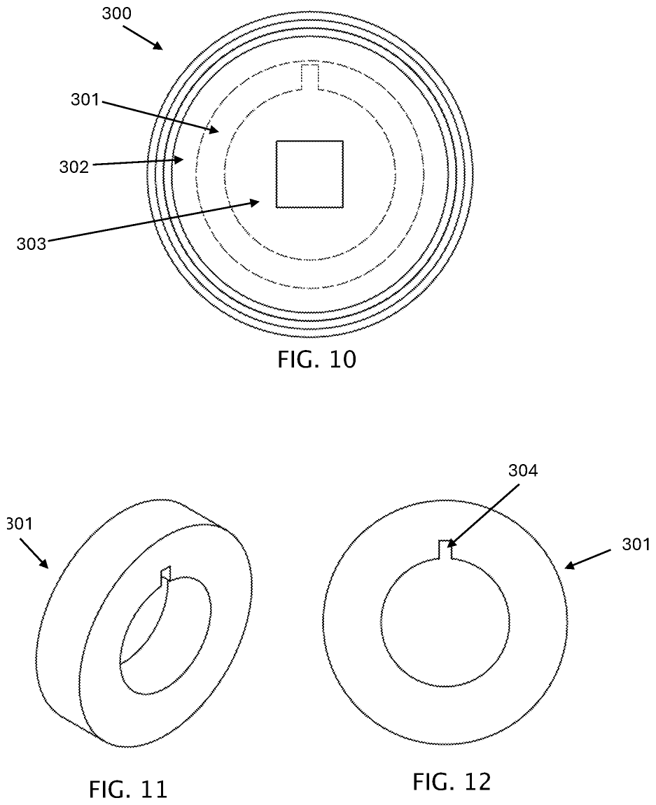

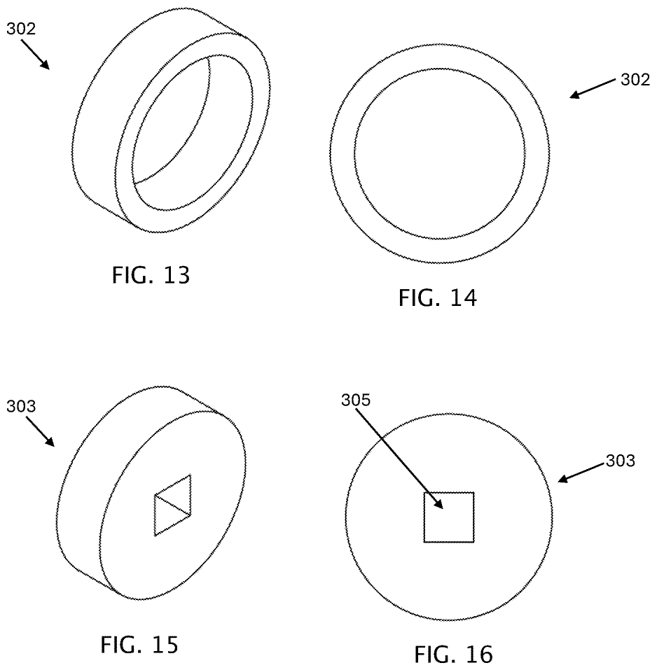

FIGS. 8-16 illustrate various embodiments of the driver component 300 and associated elements thereof. In the illustrated embodiments, the driver component 300 is shown as a socket assembly including a base member 301, a center member 302, and a top member 303, which may be fixedly coupled to one another to form a unitary or multi-piece structure. FIG. 9 illustrates an exploded view of the driver component 300, showing a base member 301 having a corresponding engagement feature 304 formed therein, a center member 302, and a top member 303 having a tool engagement feature 305 as separate components prior to assembly. It should be understood that the driver component 300 may be arranged in a variety of configurations that provide a corresponding engagement member 304 and a feature to facilitate rotation of the driver component.

The corresponding engagement feature 304 of the driver component 300 (e.g., a recess, slot, keyway, channel, or similar structure) is configured to receive at least a portion of the sacrificial torque-transfer element 200 when the sacrificial torque-transfer element 200 is positioned within the first engagement feature 102 of the driven component 100. In particular, in the depicted embodiments, the base member 301 is of primary importance, as it includes the corresponding engagement feature 304 configured to engage the sacrificial torque-transfer element 200.

The depicted driver component 300 is configured for use with a driver tool, such as a common ratchet or impact tool, to apply torque to the torque-limiting coupling system 20. The top member 303 may include a tool engagement feature 305, such as a square opening or drive interface, configured to receive and engage a corresponding portion of a driver tool (e.g., a ratchet or impact tool) to facilitate rotation of the driver component 300.

As depicted in FIG. 7, the sacrificial torque-transfer element 200 is first positioned within the first engagement feature 102 of the driven component 100, after which the driver component 300 is placed over the driven component 100 such that the sacrificial torque-transfer element 200 is simultaneously received within the corresponding engagement feature 304 of the driver component 300. In this configuration, the engagement features 102 and 304 may each be defined by a channel, recess, slot, or similar configuration configured to receive and retain the sacrificial torque-transfer element 200.

When the driver component 300 is engaged with the driven component 100 in this manner, rotation of the driver component 300 causes torque to be transmitted through the sacrificial torque-transfer element 200 to the driven component 100, thereby rotating the driven component 100. Torque is transmitted in this manner until the applied torque reaches or exceeds a predetermined threshold, at which point the sacrificial torque-transfer element 200 fails (e.g., by shearing), thereby interrupting further torque transmission. Following failure of the sacrificial torque-transfer element 200, continued rotation of the driver component 300 is decoupled from the driven component 100, such that additional rotation of the driver component 300 does not cause corresponding rotation of the driven component 100.

The driver component 300 may be formed as a unitary structure or as multiple components fixedly or removably coupled together, and may be configured for use with a variety of driver tools, including manual tools, powered tools, or impact tools.

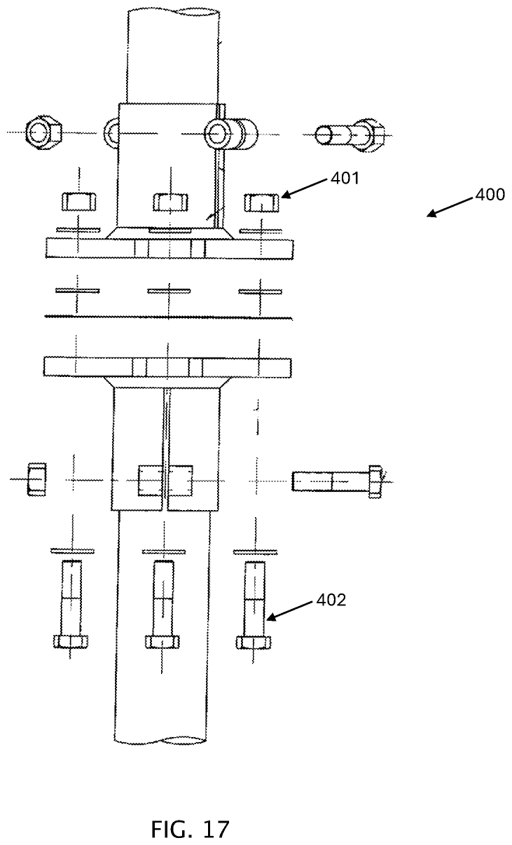

FIG. 17 illustrates a prior art mounting system 400 for breakaway roadway signposts, which typically includes fasteners such as bolts 402 and nuts 401 used to secure opposing slip-base plates together. In conventional systems, proper performance of the breakaway feature is highly dependent on the torque applied to these fasteners. In particular, it is imperative that the slip-base plates are not over-tightened, as excessive torque can inhibit or prevent the intended breakaway function of the mounting system. Additionally, it is important that the slip-base plates are not under-tightened, as insufficient torque may permit movement or rotation of the sign due to wind loads or physical contact.

In accordance with the present disclosure, the driven component 100 of the torque-limiting coupling system 20 may replace the nuts 401 used in such prior art mounting systems 400. When used in this manner, the disclosed torque-limiting coupling system 20 controls the amount of torque applied during installation, thereby preventing over-tightening and/or under-tightening of the bolts 402 that secure the slip-base plates. By limiting the applied torque to a predetermined threshold, the disclosed system promotes consistent and reliable breakaway performance of the mounting system 400, allowing the signpost to separate from the mounting base upon impact by a vehicle as intended.

As will be understood by one skilled in the art, the above-described torque-limiting coupling system can be used in countless applications where it is desirable to prevent overtightening or under-tightening of a coupling system. Furthermore, the sacrificial torque-transfer element 200, the first engagement feature of driven component 102, and the corresponding engagement feature of the driver component 304 can be arranged and configured in a variety of ways that achieve the torque-limiting functionality described herein.

It is important to note that the construction and arrangement of the elements of the invention provided herein are illustrative only. Although only a few exemplary embodiments of the present invention have been described in detail in this disclosure, those skilled in the art who review this disclosure will readily appreciate that many modifications are possible in these embodiments (such as variations in orientation of the components of the system, sizes, structures, shapes and proportions of the various components, etc.) without materially departing from the novel teachings and advantages of the invention.

Many other uses of the present invention will become obvious to one skilled in the art upon acquiring a thorough understanding of the present invention. Once given the above disclosures, many other features, modifications and variations will become apparent to the skilled artisan in view of the teachings set forth herein. Such other features, modifications and variations are, therefore, considered to be a part of this invention.

The invention claimed is:

1. A torque-limiting coupling system for use in mounting systems, comprising:
a. a driven component having a first engagement feature;
b. a driver component having a corresponding engagement feature; and
c. a sacrificial torque-transfer element configured to be received within and engaged with said first engagement feature of said driven component and said corresponding engagement feature of said driver component;
d. wherein said sacrificial torque-transfer element is configured to transmit torque between the driver component and the driven component; and
e. wherein the sacrificial torque-transfer element is configured to fail upon application of torque exceeding a predetermined threshold, thereby limiting torque transmitted from the driver component to the driven component.

2. The torque-limiting coupling system of claim 1, wherein said mounting systems are breakaway mounting systems for roadway signposts, and wherein the system prevents over-tightening of slip-base fasteners.

3. The torque-limiting coupling system of claim 2, wherein the driven component replaces a nut in a mounting system.

4. The torque-limiting coupling system of claim 3, wherein the driven component comprises a threaded body configured to receive a bolt.

5. The torque-limiting coupling system of claim 1, wherein said driven component comprises a body having a generally round configuration, a threaded center formed within the body for receiving a threaded portion of a fastener, and said first engagement feature is formed in said body.

6. The torque-limiting coupling system of claim 1, wherein said first engagement feature comprises a female keyway extending into a body of said driven component and wherein the corresponding engagement feature comprises a keyway aligned with the first engagement feature.

7. The system of claim 1, wherein at least one of the first engagement feature or the corresponding engagement feature comprises a female keyway, recess, slot, channel, or groove.

8. The system of claim 1, wherein the sacrificial torque-transfer element comprises a shearable insert, pin, tab, or elongated member.

9. The system of claim 1, wherein the sacrificial torque-transfer element is removably insertable into the first engagement feature.

10. The system of claim 1, wherein the sacrificial torque-transfer element is configured to fail by shearing, fracturing or deforming.

11. The system of claim 1, wherein failure of the sacrificial torque-transfer element results in disengagement between the driver component and the driven component.

12. The system of claim 1, wherein the driver component comprises a socket assembly.

13. The system of claim 12, wherein the socket assembly includes a base member having the corresponding engagement feature.

14. The system of claim 12, wherein the socket assembly includes a center member and a top member fixedly coupled to the base member.

15. The system of claim 14, wherein the top member includes a tool engagement feature configured to engage a driver tool.

16. The system of claim 15, wherein the tool engagement feature is configured to engage a manual tool, a powered tool, or an impact tool.

17. A method of controlling torque applied to a fastener in a mounting system, comprising:
a. positioning a sacrificial torque-transfer element between a driven component having a first engagement feature and a driver component having a corresponding engagement feature such that the sacrificial torque-transfer element is received within and engaged with the first engagement feature of the driven component and the corresponding engagement feature of the driver component;
b. applying torque to the driver component to transmit torque to the driven component through the sacrificial torque-transfer element; and
c. failing the sacrificial torque-transfer element upon the applied torque exceeding a predetermined threshold, thereby limiting further torque transmission to the driven component.

18. A torque-limiting driven component for use in a mounting system, comprising:
a. a body having a threaded center configured to receive a threaded fastener;
b. a first engagement feature formed in the body; and
c. a sacrificial torque-transfer element configured to be received within and
engaged with the first engagement feature and a corresponding engagement feature of a driver component;
d. wherein the sacrificial torque-transfer element is configured to transmit torque to the driven component and to fail upon application of torque exceeding a predetermined threshold to limit torque applied to the driven component.

19. The driven component of claim 18, wherein the sacrificial torque-transfer element is configured to be received within and engaged with said first engagement feature of said driven component and said corresponding engagement feature of said driver component.

20. The driven component of claim 18, wherein the driven component replaces a nut in the mounting system, wherein said mounting system is a breakaway mounting system for roadway signposts, and wherein the system prevents over-tightening of slip-base fasteners.
